(19) United States
(12) Patent Application Publication
(10) Pub. No.: US 2025/0343367 A1
(43) Pub. Date: Nov. 6, 2025

(54) CARD CONNECTOR

(71) Applicant: CHANT SINCERE CO., LTD., New Taipei City (TW)

(72) Inventors: Ming-Hui YEN, New Taipei City (TW); Chun-Wei WU, New Taipei City (TW)

(21) Appl. No.: 19/196,749

(22) Filed: May 2, 2025

(30) Foreign Application Priority Data
May 3, 2024 (TW) 113204501

(51) Int. Cl. H01R 12/70; H01R 12/71

(52) U.S. Cl. CPC H01R 12/7005; H01R 12/714

(57) ABSTRACT

A card connector includes an upper case, a middle intervening plate, an elastic component and a lower case. The upper case includes a plurality of upper conductive terminals each of which projects and extends downwardly from the upper case. The middle intervening plate is disposed on the bottom of the upper case, and an upper card slot is formed between the middle intervening plate and the upper case. The elastic component is located on the bottom of the middle intervening plate and projects and extends forwardly. The lower case is disposed on the bottom of the elastic component and includes a plurality of lower conductive terminals each of which projects and extends upwardly from the lower case. A lower card slot is formed between the middle intervening plate and the lower case. When the elastic component is resisted, the middle intervening plate moves toward the lower case.

### CROSS REFERENCE TO RELATED APPLICATION

This application claims the priority benefit of Taiwan Patent Application TW 113204501, filed on May 3, 2024, the full disclosure of which is incorporated herein by reference.

### BACKGROUND

### Technical Field

The present disclosure is related to a connector and is especially related to a card connector.

### Related Art

When the existing electronic device (such as a laptop) performs electrical signal transmission on a card (such as a SD card), a card connector requires mounting on the electronic device to provide the card to be inserted into the card connector so that the electronic device may access the information of the card.

The existing card connector is only provided with the insertion of the single card (such as an SD card). After the single card is inserted into the card connector, the electronic device would perform the electrical signal transmission on the card through the card connector.

The cards have different types (such as SD cards, CF cards) according to different usage scenarios, and the cards with the different types have different sizes. However, because the type of the card used by a user can not be learned when the electronic device is designed, the multiple card connectors respectively require mounting under the premise that the cards have the different types. Thus, the size of the electronic device can not be reduced.

Hence, the prior art indeed has a necessity to further provide a more improved solution.

### SUMMARY

In view of the aforementioned deficiency of the existing technology, the main object of the present disclosure is to be able to move the middle intervening plate downwardly or upwardly to induce the single card connector to handle the insertion of the cards with the different types so that there is no need to mount the multiple card connectors to achieve the purpose of reducing the size of the electronic device.

In order to achieve the aforementioned object, a technical solution adopted by the present disclosure is to mainly facilitate the card connector to include: an upper case, a middle intervening plate, an elastic component and a lower case. The upper case includes a plurality of upper conductive terminals each of which projects and extends downwardly from the upper case. The middle intervening plate is disposed on the bottom of the upper case, and there is an upper card slot formed between the middle intervening plate and the upper case. The elastic component is located on the bottom of the middle intervening plate and projects and extends forwardly. The lower case is disposed on the bottom of the elastic component, and there is a lower card slot formed between the middle intervening plate and the lower case. The lower case includes a plurality of lower conductive terminals each of which projects and extends upwardly from the lower case. The middle intervening plate moves toward the lower case when the elastic component is pressed.

Through the aforementioned elastic component, when a card is inserted into the upper card slot, the card is pressed against the middle intervening plate, and the middle intervening plate would further exert downward force on the elastic component so that the slot space of the upper card slot may be enlarged to accommodate the card and the slot space of the lower card slot would be diminished. Also, after the card is removed from the lower card slot, the position of the middle intervening plate would be restored to a preset position. Thus, when the card connector handles the cards with the different types, there is no need to mount the multiple card connectors, and the cards with different types may also be accessed so that the size of the electronic device may be significantly decreased.

### BRIEF DESCRIPTION OF THE DRAWINGS

FIG. 1 depicts a 3D view diagram of a card connector according to one embodiment of the present disclosure.

FIG. 2 is the cross section view diagram along the line A-A of FIG. 1.

FIG. 3 depicts an exploded view diagram of a card connector according to one embodiment of the present disclosure.

FIG. 4 depicts another exploded view diagram of a card connector according to one embodiment of the present disclosure.

FIG. 5 is the bottom view diagram of FIG. 4.

### DETAILED DESCRIPTION OF THE EMBODIMENTS

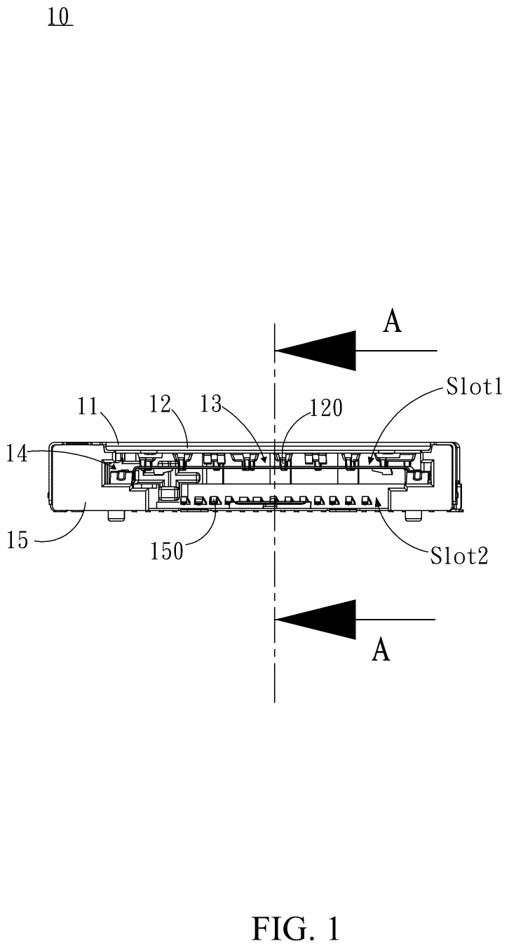

With regard to a preferred embodiment of the card connector 10 of the present disclosure, as shown in FIG. 1, the card connector 10 includes an upper cover 11, an upper case 12, a middle intervening plate 13, an elastic component 14 and a lower case 15. The upper cover 11 covers the top surface of the upper case 12. The upper case 12 includes a plurality of upper conductive terminals 120, and each upper conductive terminal 120 projects and extends downwardly from the horizontal direction of the upper case 12. The middle intervening plate 13 is disposed on the bottom of the upper case 12, and there is an upper card slot Slot1 formed between the middle intervening plate 13 and the upper case 12. The elastic component 14 is located on the bottom of the middle intervening plate 13 and projects and extends forwardly. The lower case 15 is disposed on the bottom of the elastic component 14, and there is a lower card slot Slot2 formed between the middle intervening plate 13 and the lower case 15. The lower case 15 includes a plurality of lower conductive terminals 150, and each of the plurality of lower conductive terminals 150 is configured on the lower case 15 and projects and extends upwardly from the horizontal direction of the lower case 15. When a card is inserted into the upper card slot Slot1, the elastic component is resisted by the card so that the middle intervening plate 13 moves toward the lower case 15. When the state of the elastic component 14 changes from the resisted state to the unresisted state, the position of the middle intervening plate 13 would be restored to a preset position due to the elastic force of the elastic component 14.

By the contact between the card and the aforementioned elastic component 14, the elastic component 14 is pressed against the middle intervening plate 13 to move middle intervening plate 13 downwardly. Or when the card does not contact the elastic component 14, the position of the middle intervening plate 13 would be restored to the preset position because the middle intervening plate 13 undergoes the elastic force of the elastic component 14. Thus, the cards with different sizes may be flexibly inserted into the card connector 10, thereby improving the flexible usage of the card connector 10 and reducing the entire thickness of the card connector 10. Also, there is no need to mount the multiple card connectors so that the size of the electronic device may be decreased.

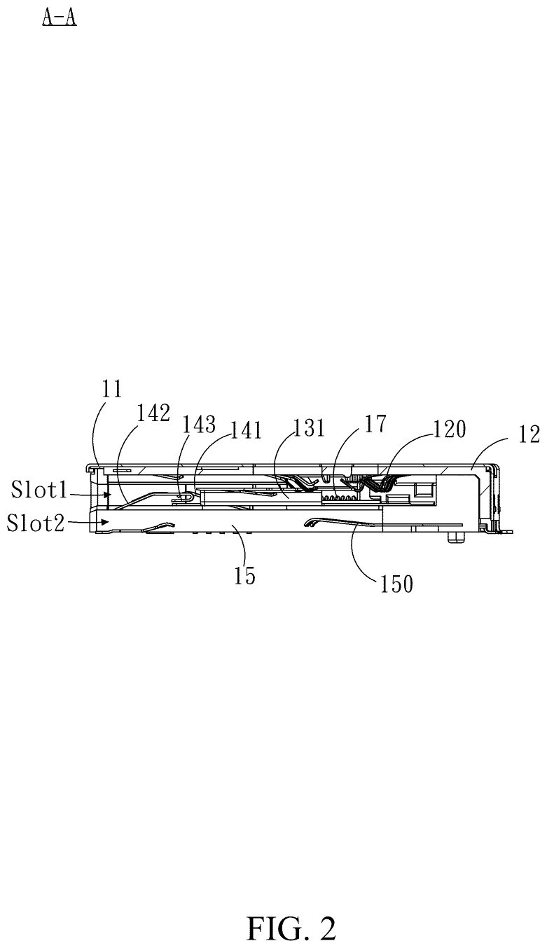

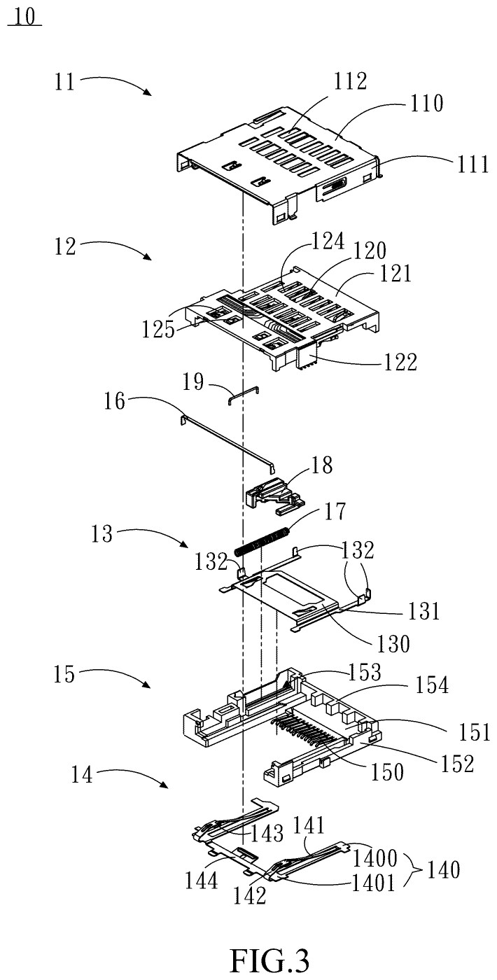

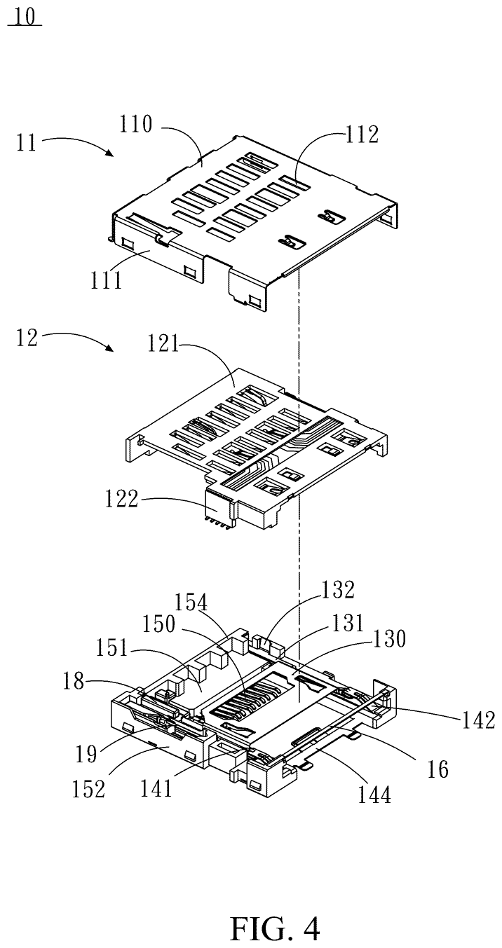

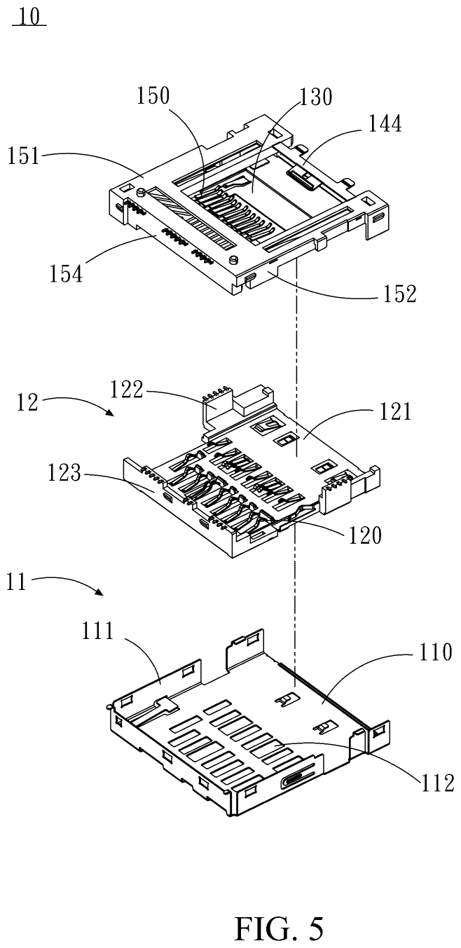

Discussing in detail, as shown in FIG. 2, FIG. 3, FIG. 4 and FIG. 5, the upper cover 11 has a plate body 110, two relative side walls 111 and a plurality of through holes 112. The bottom surface of the plate body 110 covers the top surface of the upper case 12. The two relative side walls 111 extend downwardly from the two relative lateral sides of the plate body 110 and are located on the rear side of the plate body 110. Each of the plurality of through holes 112 penetrates the rear side of the plate body 110. Specifically, the two relative side walls 111 and the two relative lateral sides close to the rear side of the plate body 110 are vertically adjoined to form an accommodation space.

The upper case 12 further includes an upper plate 121, two stepped side walls 122, a rear side wall 123, a plurality of through grooves 124 and an upper limit component 125. The two stepped side walls 122 face downwardly and extend outwardly from two relative lateral sides of the upper plate 121 to gradually project and extend and are located on the front side of the upper plate 121. The rear side wall 123 projects and extends downwardly from the rear lateral side of the upper plate 121. Each of the plurality of through grooves 124 corresponds to the corresponding through hole 112 one-on-one to penetrate the upper plate 121, each of the plurality of upper conductive terminals 120 is formed on one of the groove walls of each through groove 124 by insert molding, and the upper limit component 125 extends and forms downwardly from the front side of the upper plate 121 to the rear side of the upper plate 121. Each of the plurality of upper conductive terminals 120 extends downwardly and horizontally from the groove wall of the corresponding through groove 124 and is formed on the middle intervening plate 13 and bends downwardly in an arc shape to form an arc bending part, and the arc bending part may resist the conductive part of the card inserted into the upper card slot Slot1 so that each of the plurality of upper conductive terminals 120 is exposed inside the upper card slot Slot1. Specifically, after the arc bending part descends from the rear side of the upper plate 121 to the middle intervening plate 13 to extend the height thereof, each of the plurality of upper conductive terminals 120 bends and extends upwardly (i.e., from the middle intervening plate 13 to the upper plate 121). Thus, by the bending of each of the plurality of upper conductive terminals 120, the front end of each of the plurality of upper conductive terminals 120 forms the arc bending part; by pressing the arc bending part against the conductive part of the card, electrical signals may be stably transmitted, wherein the arc bending part is shown as the arc shape; by the aforementioned configuration of the two stepped side walls 122 and the two relative side walls 111 at the front side and the rear side of the card connector 10, the upper cover 11 and the upper case 12 may be closely combined into a continuous side wall.

The middle intervening plate 13 is disposed between the upper case 12 and the lower case 15, and the middle intervening plate 13 further includes a sheet body 130 and two bending plates 131. The sheet body 130 is disposed on the front side of the upper case 12 and the front side of the lower case 15. Each of the two bending plates 131 is disposed inside the lower case 15 and bends outwardly to form the bottom surface of the bending plate 131 after extending downwardly from the two relative lateral sides of the sheet body one-on-one. Also, each of the two bottom surfaces of the two bending plates 131 bends upwardly to form a resisting part 132 after extending backwardly and horizontally, and the lateral side of each of the two bottom surfaces of the two bending plates 131 (i.e., the lateral side far away from the sheet body 130) faces outwardly and bends upwardly to form the resisting part 132. Specifically, the two bending plates 131 are shown as L shapes, and the resisting parts 132 are formed on the rear side of the upper case 11 and the outer side of each bending plate 131.

The elastic component 14 includes two elastic sheet bodies 140, two lifting parts 141, two rebound parts 142, two turn over parts 143 and a limiting part 144. Each of the two elastic sheet bodies 140 has a first end 1400 and a second end 1401 and horizontally extends from the first end 1400 to the second end 1401, and each of lateral sides of the first end 1400 and the second end 1401 faces outwardly and horizontally extends to form a projection extending part. Each of the two lifting parts 141 is disposed between the first end 1400 and the second end 1401 and upwardly extends by degrees from the position close to the first end 1400 to the second end 1401 to lift the height thereof. Each of the two rebound parts 142 extends toward the first end 1400 in the arc shape after projecting and extending forwardly from the front edge (i.e., far away from the first end 1400) of the second end 1401; each of the two rebound parts 142 horizontally extends toward the first end 1400 after upwardly lifting the height thereof by degrees above the second end 1401. Each of the two turn over parts 143 extends downwardly from the extension end of each of the two rebound parts 142 and faces toward the second end 1401 to turn over and form between the corresponding elastic sheet body 140 and the corresponding rebound part 142; wherein each of the two lifting parts 141 at the position thereof far away from the first end 1400 bends downwardly in the arc shape and is combined with the horizontal extension of the rebound part 142. The limiting part 144 is disposed between the two second ends 1401 of the two elastic sheet bodies 140, and the two ends of the limiting part 144 are respectively connected to the two second ends 1401. Specifically, a through hole is formed and penetrates between the first end 1400 and the second end 1401 of each of the two elastic sheet bodies 140, and each of the two lifting parts 141 is located above the through hole. One of the two ends of the limiting part 144 horizontally extends toward the other second end 1401 on the relative side of the limiting part 144 after bending downwardly from one of the two second ends 1401, and bends upwardly at the position close to the other second end 1401 to connect to the other second end 1401. By the contact between the top of each of the two lifting parts 141 and the bottom surface of the bending plate 131 one-on-one, when each of the two lifting parts 141 undergoes downward thrust, each of the two lifting parts 141 and each of the two rebound parts 142 are compressed and deformed in the direction of the corresponding elastic sheet body 140 due to the middle intervening plate 13, thus inducing the middle intervening plate 13 to move downwardly.

The lower case 15 includes a lower plate 151, two side walls 152, an accommodation groove 153 and a rear wall 154. The two side walls 152 are disposed on the bottom of the lower plate 151 and extends upwardly from two relative lateral sides of the lower plate 151. The accommodation groove 153 is located on one of the two lateral sides 152 and is close to the rear wall 154. The rear wall 154 extends upwardly from the rear lateral side of the lower plate 151. Specifically, the lower plate 15 is shown as a U shape, each of the plurality of lower conductive terminals 150 faces forwardly and extends upwardly from the recess of the U shape. After being formed on the lower plate 151 by insert molding and extending from the rear side of the lower plate 151 to the middle intervening plate 13 to lift the height thereof, each of the plurality of lower conductive terminals 150 bends and extends down downwardly. Thus, by the bending of each of the plurality of lower conductive terminals 150, the front end of each of the plurality of lower conductive terminals 150 forms a contact part, and by the contact between the contact part and the conductive part of the card, electrical signals may be stably transmitted.

In the present embodiment, the card connector 10 further includes a lower limit component 16, an elastic extension component 17, a fixing block 18 and a combination component 19. The elastic extension component 17 is combined with the lower case 15. The elastic extension component 17 is disposed inside the accommodation groove 153 and is a spiral spring. The bottom of the fixing block 18 is recessed upwardly, and the fixing block 18 covers the top of the elastic extension component 17 and is further combined with the lower case 15, and the combination component 19 is combined with the top of the fixing block 18. By the elastic extension component 17, the card is easily pushed from the rear side to the front side of the card connector 10.

In view of the above description, by the aforementioned elastic component 14, when the card is inserted into the upper card slot Slot1, the card would resist the middle intervening plate 13, and the middle intervening plate 13 compresses the elastic component 14 and moves toward the lower case 15 so that the slot space of the lower card slot Slot2 is compressed and the slot space of the upper card slot Slot1 may be enlarged to accommodate the card. Also, after the card is removed from the upper card slot Slot1, the position of the middle intervening plate 13 would be restored to the preset position due to the elastic force of the elastic component 14. Thus, when the card connector handles the cards with the different types, there is no need to mount the multiple card connectors, and the cards with different types may also be accessed so that the size of the electronic device may be significantly decreased.

What is claimed is:

1. A card connector, comprising:
an upper case comprising a plurality of upper conductive terminals each of which projects and extends downwardly from the upper case;
a middle intervening plate disposed on a bottom of the upper case, wherein there is an upper card slot formed between the middle intervening plate and the upper case;
an elastic component located on a bottom of the middle intervening plate and projecting and extending forwardly; and
a lower case disposed on a bottom of the elastic component, wherein there is a lower card slot formed between the middle intervening plate and the lower case, and the lower case comprises a plurality of lower conductive terminals each of which projects and extends upwardly from the lower case;
wherein the middle intervening plate moves toward the lower case when the elastic component is pressed.

2. The card connector as claimed in claim 1, wherein the upper case comprises:
an upper plate;
two stepped side walls each of which projects and extends downwardly from two relative lateral sides of the upper plate;
a rear side wall projecting and extending downwardly from a rear lateral side of the upper plate; and
a plurality of through grooves each of which penetrates the upper plate.

3. The card connector as claimed in claim 2, wherein each of the plurality of upper conductive terminals projects and extends from the rear side of the upper plate to a front side of the upper plate.

4. The card connector as claimed in claim 3, wherein each of the plurality of upper conductive terminals is formed on the rear side of the upper plate by insert molding and bends and extends upwardly after descending from the rear side of the upper plate to the middle intervening plate to extend a height thereof.

5. The card connector as claimed in claim 4, wherein the middle intervening plate comprises:
a sheet body disposed on a front side of the upper case and a front side of the lower case; and
two bending plates respectively disposed inside the lower case and bending outwardly after extending downwardly from two relative lateral sides of the sheet body one-on-one.

6. The card connector as claimed in claim 5, wherein the elastic component comprises:
two elastic sheet bodies each of which has a first end and a second end and horizontally extends from the first end to the second end, wherein each of lateral sides of the first end and the second end faces outwardly and horizontally extends;
two lifting parts each of which upwardly extends by degrees from a position close to the first end to the second end to lift a height thereof;
two rebound parts each of which extends toward the first end in an arc shape after projecting and extending forwardly from a front edge of the second end, wherein each of the two rebound parts horizontally extends toward the first end after upwardly lifting a height thereof by degrees above the second end; and
two turn over parts each of which extends downwardly from an extension end of each of the two rebound parts and faces toward the second end to turn over and form between the corresponding elastic sheet body and the corresponding rebound part;
wherein each of the two lifting parts at a position thereof far away from the first end bends downwardly in the arc shape and is combined with a horizontal extension of the rebound part.

7. The card connector as claimed in claim 6, wherein the elastic component further comprises a limiting part of which two ends are respectively connected to the two second ends.

8. The card connector as claimed in claim 7, wherein one of the two ends of the limiting part horizontally extends toward the other second end on a relative side of the limiting part after bending downwardly from one of the two second ends, and bends upwardly at a position close to the other second end to connect to the other second end.

9. The card connector as claimed in claim 8, wherein the upper case comprises:
a lower plate;
two side walls disposed on a bottom of the lower plate and extending upwardly from two relative lateral sides of the lower plate;
an accommodation groove located on one of the two side walls; and
a rear wall extending upwardly from a rear lateral side of the lower plate.

10. The card connector as claimed in claim 9, wherein each of the plurality of lower conductive terminals projects and extends from the rear lateral side of the lower plate to a front lateral side of the lower plate.
